(19) United States
(12) Patent Application Publication
(10) Pub. No.: US 2024/0418659 A1
(43) Pub. Date: Dec. 19, 2024

(54) DEVICE AND SYSTEM FOR DETECTING RADIATION EMITTED BY A SAMPLE IRRADIATED BY AN EXCITATION BEAM

(71) Applicant: POLITECNICO DI MILANO, Milano (IT)

(72) Inventors: Carlo Ettore FIORINI, Milano (IT); Marco CARMINATI, Milano (IT)

(73) Assignee: POLITECNICO DI MILANO, Milano (IT)

(21) Appl. No.: 18/700,325

(22) PCT Filed: Oct. 13, 2022
(86) PCT No.: PCT/IB2022/059808

§ 371 Date: Apr. 11, 2024

(30) Foreign Application Priority Data
Oct. 14, 2021 (IT) 102021000026417

(51) Int. Cl. G01N 23/22

(52) U.S. Cl. CPC G01N 23/22; G01N 2223/501; G01N 2223/507

(57) ABSTRACT

A detector device of radiation emitted by a sample irradiated with an excitation beam. The detector device includes a hollow guide element having an inlet opening and an outlet opening, and is able to guide the excitation beam along a propagation axis oriented from the inlet opening to the outlet opening; and a plurality of radiation-sensitive elements, which are arranged around the hollow guide element. The sensitive elements each have an active surface, which is tilted with respect to a plane orthogonal to the axis of propagation of the excitation beam and faces the outlet opening of the hollow guide element.

### TECHNICAL FIELD

The present invention refers, in general, to the technical field of systems for detecting radiation emitted by a sample irradiated with an excitation beam. More particularly, the present invention concerns a device and a system for detecting radiation with high efficiency, i.e. configured in such a way as to maximise the collection of the radiation emitted by an irradiated sample with an excitation beam.

The radiation detection device according to the invention finds particular application in X-ray detection systems used for experiments with synchrotron light, but also in detection systems based on X-ray fluorescence analysis, for example an X-ray fluorescence (XRF) spectrometer that uses conventional sources such as X-ray tubes or a scanning electron microscope (SEM) that uses electron beams for the irradiation of the sample.

### BACKGROUND

With particular reference to X-rays, techniques for measuring X-rays emitted by a sample irradiated by radiation generated by an excitatory source, such as X-ray fluorescence spectroscopy, have over the years become essential in life and environmental sciences, medical, archaeological and cultural applications, forensic chemistry, industrial applications and non-destructive analysis of materials.

These techniques use synchrotron light to excite fluorescence in the irradiated sample and, by analysing the fluorescence spectrum collected on an X-ray detector device, it is possible to establish the chemical composition of the sample with both spatial and energetic precision. More particularly, the identification of the atoms making up the sample is carried out by analysing the spectrum that it emits following the excitation produced by irradiation with an X-ray beam. The energies emitted are in fact characteristic of the atomic species present in the material of which the sample is made, and thus enable the atomic composition of the sample analysed to be identified in a short time (measurements typically of the order of a few minutes).

In X-ray measurement techniques, the solid angle under which the detector device collects the X-rays emitted by the sample irradiated with an excitation beam is a fundamental parameter for the effectiveness of the measurement. The radiation collection capacity, combined with the maximum counting capacity of the X-ray detector device (usually limited by the signal reading and processing electronics), is a parameter that has a decisive impact on the quality and time of the measurement.

In conventional configurations of irradiation of a sample to be analysed, the X-ray beam incident on the sample is passed sideways with respect to the X-ray detector device. The solid angle under which the detector device collects the X-rays emitted by the sample is increased by bringing the detector device closer to the sample. However, beyond a certain threshold of approach, the detector device obstructs the X-ray beam, preventing a further increase in the solid angle and thus in the efficiency of collecting the radiation emitted by the sample.

It follows that, due to the technological limits in the construction of the detector devices and because of the particular mechanical needs, which are different for each experimental line, the conventional X-ray detector devices are able to collect only a small part of the solid emission angle of the sample, thus losing much of the information relating to the sample being analysed.

This leads to a lengthening of measurement times, which reduces the number of possible experiments and makes them time-consuming and costly, also deteriorating the sample, which is exposed to high-intensity X-rays for extended periods of time.

In an attempt to increase the efficiency of collecting radiation emitted by a sample, X-ray detector devices comprising a plurality of elements sensitive to X-ray, or pixels, all arranged on a plane around an opening have been developed. In use, an excitation X-ray beam is passed through the opening until it strikes the sample to be analysed. Such a planar arrangement of the X-ray sensitive elements of the X-ray detector device is illustrated in FIG. 1.

X-ray detector devices with flat X-ray-sensitive elements arranged around an opening according to the prior art are described, for example, in international patent application WO 2010/115873 A1 and in non-patent publications C. G. Ryan, et al., “Elemental X-ray imaging using the Maia detector array: The benefits and challenges of large solid-angle”, Nuclear Instruments and Methods in Physics Research, Volume 619, Issues 1-3, 1-21 Jul. 2010, Pages 37-43; D. M. Schlosser, et al., “Expanding the detection efficiency of silicon drift detectors”, Nuclear Instruments and Methods in Physics Research A624 (2010) 270-276; and C. Rumancev, et al., “X-ray fluorescence analysis of metal distributions in cryogenic biological samples using large-acceptance-angle SDD detection and continuous scanning at the Hard X-ray Micro/Nano-Probe beamline P06 at PETRA III”, J. Synchrotron Rad. (2020). 27, 60-66.

X-ray detector devices with flat X-ray-sensitive elements arranged around an opening enable the distance between the X-ray-sensitive elements and the sample to be reduced, so that the detector device can collect the X-rays emitted by the sample more efficiently. This is because the geometric constraints limiting the approach of the detector device to the sample are removed.

The planar configuration of the X-ray-sensitive elements, however, has limitations in collecting the X-rays emitted by the sample. In fact, the X-ray-sensitive elements furthest from the central opening (e.g. the most peripheral pixels in FIG. 1), which are also those more tilted with respect to the direction of the X-rays emitted by the sample, collect fewer X-rays than those closer to the central opening. This solution, albeit efficient, does not optimise the use of the X-ray-sensitive elements and the collection of X-rays.

The X-ray detector devices with a flat configuration and central opening of the X-ray-sensitive elements according to the prior art, in particular those of the monolithic type, finally have a further disadvantage linked to their very complex structure, which usually requires wire-bonding type connections, and are therefore extremely expensive.

### SUMMARY

It is an object of the present invention to overcome the disadvantages of the prior art.

In particular, an object of the invention is to present a device and system for detecting radiation configured to maximise the collection of the radiation emitted by a sample irradiated by an excitation beam.

Another object of the invention is to present a radiation detection device provided with a simplified structure and thus low production costs.

These and other object of the present invention are achieved by a device and a system for detecting radiation incorporating the features of the appended claims, which form an integral part of the present disclosure.

In a first aspect thereof, the invention is therefore directed to a detector device of radiation emitted by a sample irradiated with an excitation beam. The detector device comprises a hollow guide element having an inlet opening and an outlet opening and able to guide the excitation beam along a propagation axis oriented from the inlet opening to the outlet opening and a plurality of radiation-sensitive elements which are arranged around the hollow guide element. The radiation-sensitive elements each have an active surface, which is tilted with respect to a plane orthogonal to the axis of propagation of the excitation beam and faces the outlet opening of the hollow guide element.

Thanks to this combination of features, in particular thanks to the fact that the radiation-sensitive elements each have an active surface which is tilted with respect to a plane orthogonal to the axis of propagation of the excitation beam and faces the outlet opening of the hollow guide element that guides the excitation beam, the sensitive elements are, in use, optimally tilted in the direction of a sample to be analysed, so it is possible to maximise the solid angle subtended by the radiation detector device, with the same total area of the sensitive elements used. This results in an optimisation of the overall efficiency of collection, by the detector device, of the radiation emitted by the sample analysed.

Furthermore, the tilted arrangement of the radiation-sensitive elements with respect to the sample allows the radiation emitted by the sample to be collected with greater uniformity between the different sensitive elements, whereby all the sensitive elements can operate at the maximum counting capacity allowed by the signal reading and processing electronics, thus maximising the overall counting capacity of the radiation detector device.

In one embodiment, the detector device comprises a support structure for the radiation-sensitive elements, which is provided with a passage opening of the hollow guide element.

In one embodiment, the support structure comprises a plate, in which the passage opening of the hollow guide element is formed, and a plurality of blocks, rising from the base, for connecting the sensitive elements to the plate.

In one embodiment, the support structure comprises a curved, preferably hemispherical, support surface in which the passage opening of the hollow guide element is formed and the radiation-sensitive elements are arranged on a concave face of the curved support surface.

In one embodiment, the radiation-sensitive elements are arranged symmetrically around the hollow guide element. Alternatively, the radiation-sensitive elements are arranged asymmetrically around the hollow guide element.

In one embodiment, the radiation-sensitive elements are flat, preferably curved.

In one embodiment, each sensitive element of the plurality of radiation-sensitive elements comprises a chip in turn comprising a monolithic array composed of a single radiation-sensitive unit or multiple radiation-sensitive units integrated on the same monolithic chip.

In one embodiment, each radiation-sensitive unit is of the silicon drift type or germanium drift type.

In one embodiment, the radiation-sensitive elements are housed in a box-shaped, which comprises a base supporting the sensitive elements, closed by a lid. A respective radiolucent window is formed in the base and in the lid, each window being arranged in correspondence with the sensitive elements and preferably coaxial to the hollow guide element intended to guide the excitation beam.

In one embodiment, the detector device comprises a printed circuit board, to which the radiation-sensitive elements are electrically connected by means of a connector.

In one embodiment, the hollow guide body is made of a material, for example molybdenum, capable of shielding the radiation-sensitive elements from the excitation beam that passes through it.

In one embodiment, the detector device comprises a thermoelectric cooling device.

In one embodiment, two longitudinal holes are made in the base for the circulation, inside the detector device, of a cooling fluid, preferably water.

In one embodiment, the radiations collected by the detector device are X-rays or electrons and the excitation beam is an X-ray beam or an electron beam.

In a second aspect thereof, the invention is directed to a system for detecting radiation emitted by a sample irradiated with an excitation beam, the detector system comprising a source of the excitation beam and a radiation detector device as defined above.

Further features and advantages of the present invention will be more evident from the description of the accompanying drawings.

### BRIEF DESCRIPTION OF THE DRAWINGS

The invention will be described below with reference to some examples, provided by way of non-limiting example, and illustrated in the appended drawings. These drawings illustrate different aspects and embodiments of the present invention and reference numerals illustrating structures, components, materials and/or similar elements in different drawings are indicated by similar reference numerals, where appropriate.

FIG. 1 is a schematic perspective view of a planar configuration of a plurality of radiation-sensitive elements of a radiation detector device according to the prior art, when collecting radiation emitted by a sample irradiated with an excitation beam.

FIG. 2 is a schematic perspective view of a radiation detector device according to the present invention.

FIG. 3 is an enlarged perspective view, taken from another angle, of the radiation detector device of FIG. 2, with parts removed to show the arrangement of the radiation-sensitive elements.

FIG. 4 is a side perspective view of the radiation-sensitive elements of the radiation detector device in FIG. 2.

FIG. 5 is a perspective view from above of the sensitive elements of FIG. 4.

FIG. 6 is a cross-sectional and partial perspective view of the radiation detector device of FIG. 2.

FIG. 7 is a schematic view of an alternative arrangement of the radiation-sensitive elements of the radiation detector device of FIG. 2, when collecting radiation emitted by a sample irradiated with an excitation beam.

FIG. 8 is a longitudinal sectional view of the radiation-sensitive elements of FIG. 7.

FIG. 9 is a bottom view of yet another arrangement of radiation-sensitive elements of the radiation detector device of FIG. 1.

FIG. 10 is a schematic view of a system for detecting radiation according to the present invention.

### DETAILED DESCRIPTION OF THE EMBODIMENTS

While the invention is susceptible to various modifications and alternative constructions, some embodiments provided for explanatory purposes are described in detail below.

It must in any case be understood that there is no intention to limit the invention to the specific embodiment illustrated, but, on the contrary, the invention intends covering all the modifications, alternative and equivalent constructions that fall within the scope of the invention as defined in the claims.

In the following description, therefore, the use of “e.g.”, “etc.”, “or” indicates non-exclusive alternatives without limitation, unless otherwise indicated; the use of “also” means “including, but not limited to” unless otherwise indicated; the use of “includes/comprises” means “includes/comprises, but not limited to” unless otherwise indicated.

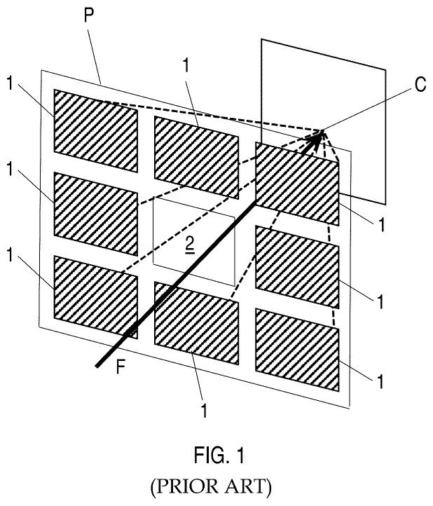

With reference to FIG. 1, it illustrates a configuration of elements sensitive to radiation, in particular X-rays, of a radiation detector device according to the prior art.

As explained above, the elements sensitive to X-ray or pixels are arranged on a plane P, on which a central opening 2 is formed for the passage of an X-ray beam F of excitation of a sample C. Once irradiated with the excitation beam, the sample C emits radiation (indicated with dashed lines in the figure), which are collected by the sensitive elements 1.

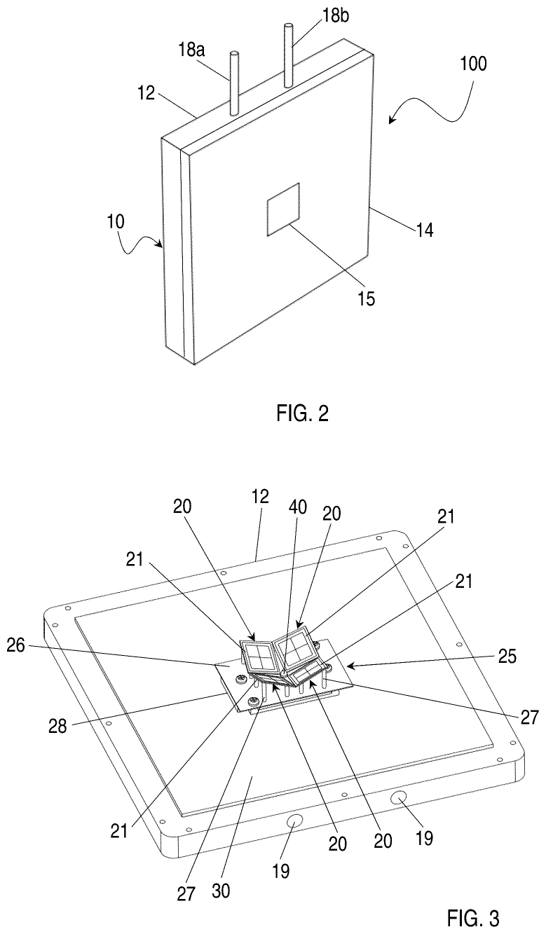

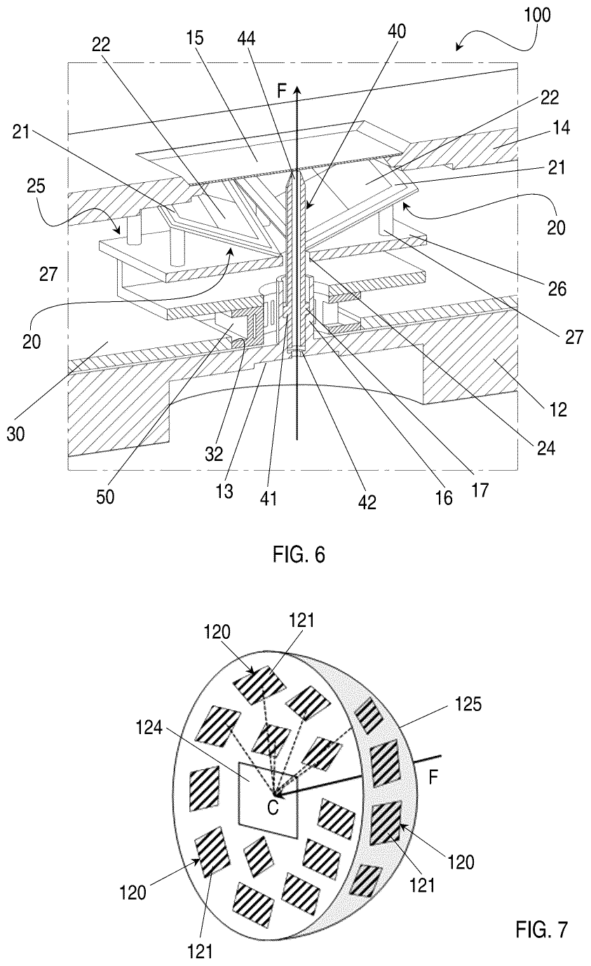

FIGS. 2 and 6 instead illustrate a detector device of radiation, for example X-rays or electrons, according to a preferred embodiment of the present invention.

The radiation detector device, generally referred to by the reference numeral 100, comprises a box-shaped 10 containing a plurality of elements sensitive to radiation or pixels 20. In particular, the box-shaped 10 is an internally hollow body comprising a base 12, preferably made of copper, closed by a lid 14, preferably made of aluminium.

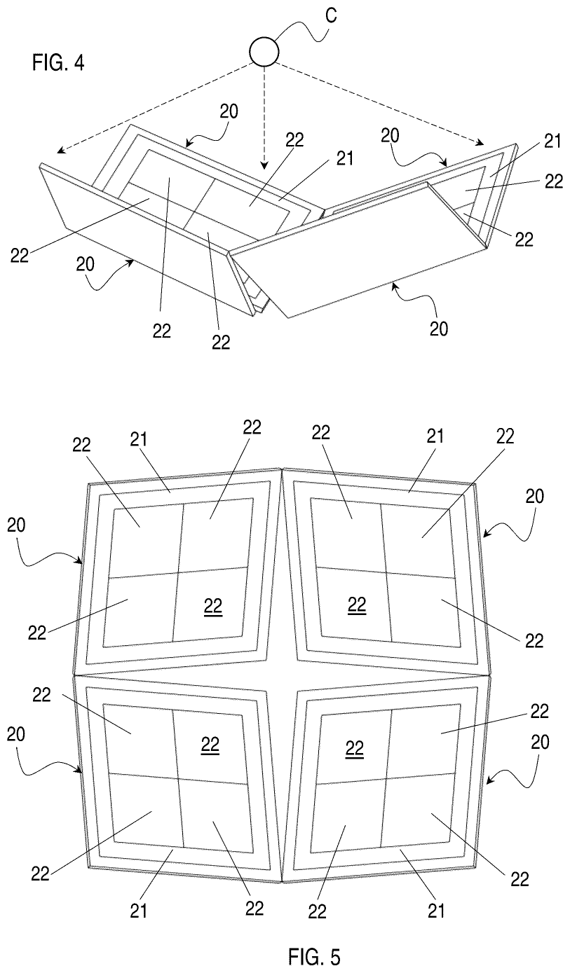

The sensitive elements 20 are configured to collect radiation (indicated with a dashed line in FIG. 4), for example X-rays or electrons, emitted by a sample C (shown in FIG. 4) irradiated with a beam F of excitation (shown in FIG. 6) of the sample C, for example an X-ray beam or an electron beam.

As shown in detail in FIG. 6, the detector device 100 further comprises a hollow guide element 40, housed in the box-shaped 10 and having an inlet opening 42 and an outlet opening 44. In particular, the hollow guide element 40 has a cylindrical inner channel and is configured to guide the excitation beam F along a propagation axis oriented from the inlet opening 42 to the outlet opening 44.

Furthermore, radiolucent windows, respectively 13 and 15, preferably coaxial with the hollow guide element 40, are formed on the base 12 and on the lid 14 of the box-shaped 10, and in correspondence with the radiation-sensitive elements 20.

The radiolucent windows 13 and 15 are preferably made of beryllium or Mylar® and allow the passage, through the detector device 100, of the beam F of excitation of the sample C. The window 15 of the lid 14 also allows the entry, in the detector device 100, of the radiation emitted by the sample C, irradiated with the excitation beam F, for the collection thereof on the radiation-sensitive elements 20.

The hollow guide element 40 is preferably made of molybdenum, so as to be capable of shielding the radiation-sensitive elements 20 of the detector device 100 from the excitation beam F that passes through it, after having entered the detector device 100 through the radiolucent window 13 of the base 12 and which, in particular, is reflected (backscattering) by the window 15 of the lid 14.

As can be seen in FIG. 3, a multilayer printed circuit board (PBC) 30 is supported on the base 12, containing the electronic components of the detection device 100. A passage opening 32 of the hollow guide element 40 is also made in the multilayer PCB 30. The opening 32 is preferably coaxial with the hollow guide element 40.

In the example of FIGS. 3 to 6, the detector device 100 comprises four radiation-sensitive elements 20 each consisting of a flat element on which face, specifically the face directed, in use, towards the sample C to be analysed, an active surface 21 is arranged, sensitive to the radiation to be detected.

Referring again to FIG. 6, the radiation-sensitive elements 20 are further arranged around the hollow guide element 40 such that their active surface 21 is tilted with respect to a plane orthogonal to the axis of propagation of the excitation beam F and faces the outlet opening 44 of the hollow guide element 40. It follows that, when the detector device 100 is in use, each radiation-sensitive element 20 is tilted in the direction of the sample C to be analysed.

As shown in greater detail in FIGS. 4 and 5, the radiation-sensitive elements 20 are also arranged symmetrically to the hollow guide element 40 guiding the excitation beam F which, by striking the sample C, generates the radiation subsequently detected by the sensitive elements 20.

The active surface 21 of each radiation-sensitive element 20 comprises a chip comprising a monolithic array composed of multiple radiation-sensitive units 22 integrated on the same chip, preferably four radiation-sensitive units 22 for a total of sixteen radiation-sensitive units. Alternatively, the active surface 21 of each sensitive element 20 may comprise a monolithic chip with a single sensitive unit.

Preferably, each radiation-sensitive unit 22 is of the semiconductor type, more preferably of the silicon drift type (SDD-Silicon Drift Detector), i.e. comprising a silicon diode configured in rings with a central anode for collecting the radiation emitted by the sample C. The sensitive units 22 can be made of a material even different from silicon, e.g. other semiconductors, such as germanium.

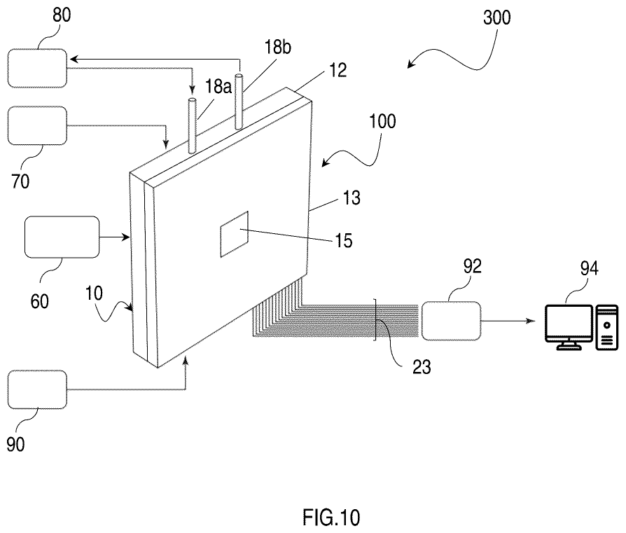

The use of SDD sensitive units 22 further allows to optimise the overall efficiency of the detector device 100. In fact, thanks to the presence of a single central anode, each SDD sensitive unit 22 has a single analogue channel of signal transmission (see the sixteen analogue channels 23 shown in FIG. 10), so that the expensive wire-bonding type connections typical of the X-ray detector devices of the prior art, in particular those with a monolithic structure, are avoided. In addition, the SDD sensitive units 22 have more advantageous noise characteristics.

Referring again to FIG. 3, the radiation 20 sensitive elements 20 of the detector device 100 are supported by a structure 25 comprising a plate 26 from which a plurality of feet 27 connecting the sensitive elements 20 to the plate 26 raise. The supports for the sensors may be other than feet, for example they may consist of monolithic blocks of metal or other material.

From the plate 26, on the opposite side to that from which the feet 27 rise, a connector 28 connecting the sensitive elements 20 of the detector device 100 to the multilayer PCB 30 extends. In the plate 26 there is also obtained a passage opening 24 (see FIG. 6) of the hollow guide element 40. The opening 24 is preferably coaxial with the hollow guide element 40.

Preferably, in correspondence with the radiolucent window 13, a hollow sleeve 16, into which the hollow guide element 40 passes, raise from the base 12. Preferably, the hollow sleeve 16 and the hollow guide element 40 are coaxial.

In order to hold the hollow guide element in position within the hollow sleeve 16, on an outer surface of the hollow guide element an annular relief 41 is preferably formed, intended to mate with a corresponding groove 17, also annular, obtained on an inner surface of the hollow sleeve 16.

Two longitudinal holes 19 are made in the base 12 for the circulation, inside the detector device 100, of a flow of water, or other cooling fluid. The cooling fluid enters the detector device 100 through an entrance conduit 18a (shown in FIG. 2), in fluid communication with one of the two longitudinal holes 19 of the base 12, cools the components of the detector device 100, and exits the detector device through an exit conduit 18b (shown in FIG. 2) in fluid communication with the other of the two longitudinal holes 19 of the base 12.

The detector device 100 further comprises a thermoelectric cooling device (TEC) 50, which is positioned in the opening 32 of the multilayer PCB 30 and around the hollow guide element 40. The TEC device 50 makes it possible to dissipate the heat coming from the structure 25 and from the elements connected to it, so as to cool the radiation-sensitive elements 20.

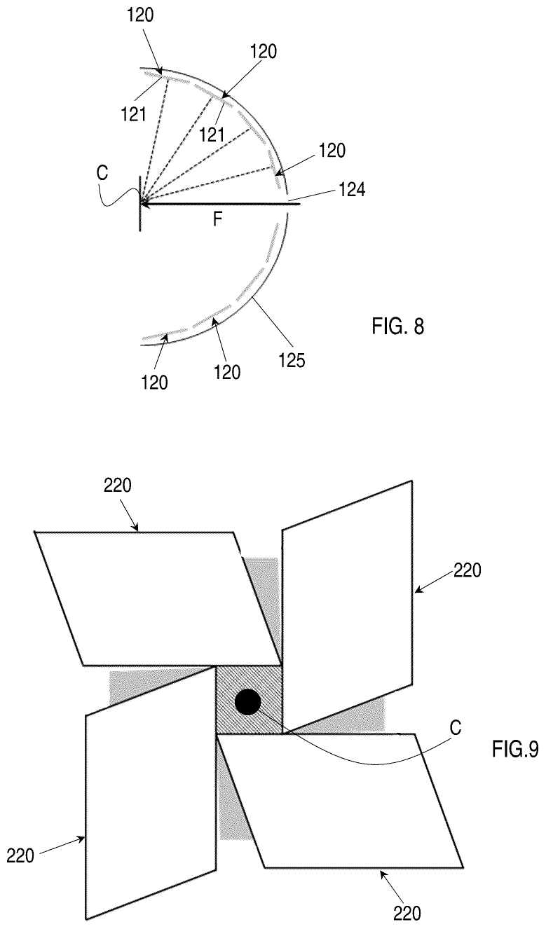

With reference to FIGS. 7 and 8, they show a different arrangement of a plurality of radiation-sensitive elements of the detector device 100 according to the present invention, which differs from that described above with reference to FIGS. 3 to 6 in that it provides for a number of sensitive elements 120 greater than four, which are arranged on a structure consisting of a curved support surface 125, in the figures a hemispherical surface. In particular, the sensitive elements 120 are arranged on a concave face of the curved support surface 125.

On the hemispherical surface 125, an opening 124 is obtained through which passes the hollow guide element 40 (not shown in FIGS. 7 and 8, but visible in FIG. 6) for guiding the beam F of excitation of the sample C to be analysed and the sensitive elements are arranged on the hemispherical surface 125 around the opening 124, and therefore around the hollow guide element 40, so as to collect the radiation (indicated with a dashed line) emitted by the irradiated sample C.

More particularly, the sensitive elements 120 have a face, in use, facing the sample C to be analysed, on which there is arranged an active surface 121, sensitive to the radiation to be detected. The radiation-sensitive elements 120 are further arranged around the hollow guide element 40 such that their active surface 121 is tilted with respect to a plane orthogonal to the axis of propagation of the excitation beam F and faces the outlet opening 44 of the hollow guide element 40.

It follows that, when the detector device 100 is in use, the sample C to be analysed is positioned directed inwardly of the hemispherical support surface 125, and therefore towards the sensitive elements 120 of the detector device 100, in a central position with respect to the hemispherical support surface 125, and thus coaxial with the central opening 124.

In the illustrated embodiment, the radiation-sensitive elements 120 are flat, but the use of curved sensitive elements, for example made of plastic and flexible materials, is also not excluded.

Further, and as described above with reference to the radiation-sensitive elements 20, each radiation-sensitive element 120 may comprise a chip, which includes a single radiation-sensitive unit, or may comprise a monolithic array composed of multiple radiation-sensitive units integrated into the same chip, e.g., a monolithic array composed of four radiation-sensitive units. Furthermore, each radiation-sensitive element 120 is preferably of the semiconductor type, more preferably of the silicon drift detector (SDD) type or of the germanium drift type.

With reference to FIG. 9, it shows yet another arrangement of a plurality of radiation-sensitive elements of the detector device 100 according to the present invention, which differs from the arrangement with four sensitive elements, described above and illustrated in FIGS. 3 to 6, in that the sensitive elements are arranged asymmetrically with respect to the hollow guide element 40 guiding the beam F of excitation of the sample C to be analysed.

The detector device 100, therefore, comprises four radiation-sensitive elements 220 each consisting of a flat element on a face of which, that in use faces the sample C to be analysed, an active surface (not visible in FIG. 9), sensitive to the radiation to be detected, is arranged.

The sensitive elements are further arranged around the hollow guide element 40 (not shown in FIGS. 7 and 8, but visible in FIG. 6), so that their active surface is tilted with respect to a plane orthogonal to the axis of propagation of the excitation beam F and faces the outlet opening 44 of the hollow guide element 40. It follows that, when the detector device 100 is in use, each radiation-sensitive element 220 is tilted in the direction of the sample C to be analysed.

Also in this case, each radiation-sensitive element 220 may comprise a chip comprising a single radiation-sensitive unit or a monolithic array composed of multiple radiation-sensitive units, integrated into the same chip, for example a monolithic array composed of four radiation-sensitive units. Furthermore, each sensitive unit is preferably of the semiconductor type, more preferably of the silicon drift type (SDD-Silicon Drift Detector) or of the germanium drift type.

With reference to FIG. 10, a system for detecting X-ray according to the present invention is shown therein.

The detection system, indicated by the reference numeral 300, comprises a source 60 of a beam F of excitation of a sample C to be analysed, for example an X-ray beam or an electron beam, and a detection device 100 described above and illustrated in FIGS. 2 to 9.

The detection system 300 further comprises a vacuum pump 70, for maintaining the vacuum inside the box-shaped 10, a chiller 80, for cooling water circulating in the detector device 100 through the conduits 18a and 18b, and a supply unit 90.

The detection system 300 further comprises one or more pulse processors, analogue or digital, which receive input signals from the detector device 100 via the analogue channels 23, process them and transmit the result of the processing to a personal computer 94.

From the above description, it is evident how the device and the radiation detection system described above, enable the proposed objects to be achieved. In particular, it is evident how the device and the system for detecting radiation can maximise the solid angle, with the same total area of the radiation-sensitive elements used, with consequent optimisation of the overall efficiency of collection of the radiation emitted by the sample C. Furthermore, the radiation detector device according to the invention is capable of collecting the radiation emitted by the sample with greater uniformity between the different radiation-sensitive elements, so that all the sensitive elements can operate, ideally, at the maximum counting capacity allowed by the signal reading and processing electronics, with consequent maximisation of the overall counting capacity of the radiation detector device.

It is therefore obvious to a person skilled in the art that it is possible to make changes and variations to the solution described with reference to the figures without departing from the scope of protection of the present invention as defined by the appended claims. For example, any inclination and arrangement of the radiation-sensitive elements around the sample can be envisaged which are aimed at optimising the total solid angle and making the unit counting uniform, compatibly with aspects connected with overall dimensions and mechanical, electrical and thermal interconnections of the sensitive elements.

1-18. (canceled)

19. A detector device of radiation emitted by a sample irradiated with an excitation beam, the detector device comprising:
a hollow guide element having an inlet opening and an outlet opening, the hollow guide element able to guide the excitation beam along a propagation axis oriented from the inlet opening to the outlet opening; and
a plurality of elements sensitive to radiation, which are arranged around the hollow guide element;
wherein the sensitive elements each have an active surface which is tilted with respect to a plane orthogonal to the axis of propagation of the excitation beam and which faces the outlet opening of the hollow guide element.

20. The detector device according to claim 19, further comprising a support structure for the radiation-sensitive elements, the support structure being provided with an opening for the passage of the hollow guide element.

21. The detector device according to claim 19, wherein the support structure comprises a plate, in which the passage opening of the hollow guide element is formed, and a plurality of blocks, rising from the plate, for connecting the sensitive elements to the plate.

22. The detector device according to claim 19, wherein the support structure comprises a curved support surface, in which the passage opening of the hollow guide element is formed, the radiation-sensitive elements being arranged on a concave face of the curved support surface.

23. The detector device according to claim 22, wherein the curved support surface is hemispherical.

24. The detector device according to claim 19, wherein the radiation-sensitive elements are arranged symmetrically around the hollow guide element.

25. The detector device according to claim 19, wherein the radiation-sensitive elements are arranged asymmetrically around the hollow guide element.

26. The detector device according to claim 19, wherein the radiation-sensitive elements are flat.

27. The detector device according to claim 19, wherein the radiation-sensitive elements are curved.

28. The detector device according to claim 19, wherein each sensitive element of the plurality of radiation-sensitive elements comprises a chip that, in turn, comprises a monolithic array composed of a single sensitive unit or multiple sensitive units integrated on the same monolithic chip.

29. The detector device according to claim 28, wherein each sensitive unit is of a silicon drift type or germanium drift type.

30. The detector device according to claim 19, wherein the radiation-sensitive elements are housed in an internally hollow, box comprising a base (for supporting the sensitive elements, closed by a lid, a respective radiolucent window is formed in the base and in the lid, and each window is arranged in correspondence with the sensitive elements.

31. The detector device according to claim 19, further comprising a printed circuit board to which the radiation-sensitive elements are electrically connected by a connector.

32. The detector device according to claim 19, wherein the hollow cylindrical body is made of a material capable of shielding the radiation-sensitive elements from the excitation beam that passes through the material.

33. The detector device according to claim 19, further comprising a thermoelectric cooling device.

34. The detector device according to claim 30, wherein two longitudinal holes are made in the base for the circulation, inside the detector device, of a cooling fluid.

35. The detector device according to claim 19, wherein the radiations are X-rays or electrons and the excitation beam is an X-ray beam or an electron beam.

36. A system for detecting radiation emitted from a sample irradiated with an excitation beam, the system comprising a source of the excitation beam and a detector device according to claim 19.
